(19) United States
(12) Patent Application Publication
(10) Pub. No.: US 2007/0069660 A1
(43) Pub. Date: Mar. 29, 2007

(54) ELECTRODELESS LIGHTING SYSTEM HAVING RESONATOR WITH DIFFERENT APERTURE RATIO PORTIONS

(75) Inventor: Yong-Seog JEON, Gyeonggi-Do (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/536,271

(22) Filed: Sep. 28, 2006

(30) Foreign Application Priority Data
Sep. 28, 2005 (KR) 10-2005-0090817

(51) Int. Cl. H05B 41/24

(52) U.S. Cl. 315/248

(57) ABSTRACT

A resonator for an electrodeless lighting system may include an inner space configured to receive an electrodeless bulb that emits light by plasmarizing a light emitting material filled inside of the electrodeless bulb. Additionally, the resonator may have light transmission holes configured to shield microwaves, generated by a microwave generator and applied to the inner space, from being discharged to an exterior of the resonator. Thus, the resonator may be configured to transmit light emitted from the electrodeless bulb. Further, the resonator may be provided with a low aperture ratio portion that has a low aperture ratio extending from a predetermined region in a circumferential direction of the resonator, and a high aperture ratio portion that has a higher aperture ratio than the low aperture ratio portion. In this regard, the high aperture ratio portion may be formed in the remainder of the circumferential direction of the resonator.

### RELATED APPLICATION

The present disclosure relates to a subject matter contained in priority Korean Application No. 10-2005-0090817, filed on Sep. 28, 2005, which is herein expressly incorporated by reference in its entirety.

### BACKGROUND OF THE INVENTION

1. Field of the Invention

The present invention relates to an electrodeless lighting system having a resonator with different aperture ratio portions. More particularly, the present invention relates to an electrodeless lighting system having a resonator with different aperture ratio portions for constraining interruption between the electrodeless lighting system and peripheral equipment (caused by a leakage of microwaves) by preventing microwaves from leaking out of the resonator.

2. Background of the Invention

FIG. 1 is a sectional view illustrating a structure of a related art electrodeless lighting system, FIG. 2 is a perspective view illustrating a coupled structure between a wave guide and a resonator, and FIG. 3 is a perspective view illustrating a direction in which an electric field of the resonator of FIG. 1 is applied.

As illustrated therein, a related art electrodeless lighting system comprises a casing 10 in which a high voltage generator 20, a microwave generator 30 and a wave guide 40 are disposed, a resonator 50 disposed outside the casing 10 and connected to an end portion of the wave guide 40, and an electrodeless bulb 60 positioned at a center of an inner space of the resonator 50 for emitting light.

One side surface of the wave guide 40 is connected to the microwave generator 30. A resonator coupling member 41, which has a particular height, is protruded from an upper surface of the wave guide 40 in a height (longitudinal) direction of the wave guide 40.

The resonator coupling member 41 is formed in a ring (annular) shape and has a diameter that is smaller than that of the wave guide 40, and its center is penetrated by the electrodeless bulb 60. A mirror 70 having a circular plate shape, which has the same diameter as that of the resonator coupling member 41, is disposed at an upper end of the resonator coupling member 41.

The electrodeless bulb 60 extends from the center of the mirror 70 in the height direction of the wave guide 40 so that it has a predetermined length, thereby being exposed to the outside of the casing 10. The resonator 50 is in contact with a peripheral surface of the resonator coupling member 41 and the mirror 70 such that the resonator is fixedly coupled to the wave guide 40.

The resonator 50 is in the form of a cylindrical mesh having a net-like structure such that the electrodeless bulb 60 is received in its inner space, microwaves are shielded from being discharged to the outside and are delivered to the electrodeless bulb 60, and light emitted from the electrodeless bulb 60 is transmitted to the outside.

A lower surface of the mesh is penetratingly formed to be in contact with an outer circumferential surface of the resonator coupling member 41 for coupling. A plurality of light transmission holes 51 are formed through a side surface and an upper surface of the mesh.

The electrodeless bulb 60 comprises a spherical light emitting portion 61 that has a predetermined inner volume for filling a filling material(s), and a fixing portion 62, formed of the same material as that of the light emitting portion 61, that extends from the light emitting portion 61. The light emitting portion 61 is installed inside the casing 10, and the fixing portion 62 is installed to be formed into the center portion of the wave guide 40.

According to this construction, regarding the related art electrodeless lighting system, upon inputting a driving signal to the high voltage generator 20, the high voltage generator 20 boosts an alternative current (AC) power source and applies the boosted high voltage to the microwave generator 30, which is then oscillated by the high voltage to generate microwaves having an extremely high frequency. The generated microwaves are radiated (emitted) into the resonator 50 via the wave guide 40 thereby exiting inactive gases filled in the electrodeless bulb 60. Accordingly, light emitting materials are continuously plasmarized thereby emitting light having a specific discharge spectrum. The emitted light is reflected forward by the mirror 70 to light up a space.

However, in the related art electrode lighting system, the microwaves, which are generated in the microwave generator 30 and then applied into the resonator 50 via the wave guide 40, may leak at different amounts out of the resonator 50, through the light transmission holes 51 of the resonator 50, in a circumferential direction of the resonator 50. Additionally, the light transmission holes 51, which are penetratingly formed at the surface of the resonator 50, have the same size. Therefore, in the electrode lighting system of the prior art, the leakage of the microwaves can not effectively be prevented. Thus, the leakage of the microwaves may cause interference between the electrodeless lighting system and its peripheral equipment.

### SUMMARY OF THE INVENTION

Therefore, an object of the present invention is to provide an electrodeless lighting system having a resonator with different aperture ratio portions capable of constraining interference between the electrodeless lighting system and peripheral equipment (caused by a leakage of microwaves) by preventing microwaves from being leaked out of the resonator.

To achieve these and other advantages and in accordance with the purpose of the present invention, as embodied and broadly described herein, there is provided an electrodeless lighting system having a resonator with different aperture ratio portions, the electrodeless lighting system includes an electrodeless bulb that emits light by plasmarizing light emitting materials filled therein; and a generally cylindrical shaped resonator that receives the electrodeless bulb in an inner space thereof, the resonator having light transmission holes configured to shield microwaves, which are generated by a microwave generator and applied to the inner space, from being discharged to an exterior of the resonator. Additionally, the resonator is configured to transmit light emitted from the electrodeless bulb, and the resonator includes a low aperture ratio portion having a low aperture ratio extending from a predetermined region (e.g., from a portion or part thereof, etc) of a circumferencial direction of the resonator in a height direction of the resonator such that a relatively small amount of microwaves may leak, and a high aperture ratio portion having a higher aperture ratio portion than the low aperture ratio portion. In this regard, the high aperture ratio portion may be formed in the remainder of the circumferential direction of the resonator such that a large (or great) amount of light emitted from the electrodeless bulb may be transmitted to the outside (e.g., the exterior) of the resonator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The present invention is further described in the detail description which follows, in reference to the noted plurality of drawings, by way of non-limiting examples of preferred embodiments of the present invention, in which like characters represent like elements throughout the several views of the drawings, and wherein:

FIG. 1 is a sectional view illustrating a structure of a related art electrode lighting system;

FIG. 2 is a perspective view illustrating a coupled structure between a wave guide and a resonator of FIG. 1

FIG. 3 is a perspective view illustrating a direction in which an electric field of the resonator of FIG. 1 is applied;

FIG. 4 is a perspective view illustrating a coupled structure between a wave guide and an electrodeless lighting system having a resonator with different aperture ratio portions in accordance with an embodiment of the present invention;

FIG. 5 is a graph illustrating a direction of an electric field and a measurement result of leakage amount of microwaves in the resonator;

FIG. 6 is a plane view illustrating different aperture ratio portions of the resonator of FIG. 4; and

FIG. 7A is a sectional view illustrating regions of a lower surface of a wave guide, and FIG. 7B is a table illustrating measured sizes and thicknesses of aperture ratio portions according to the regions of the resonator of FIG. 4.

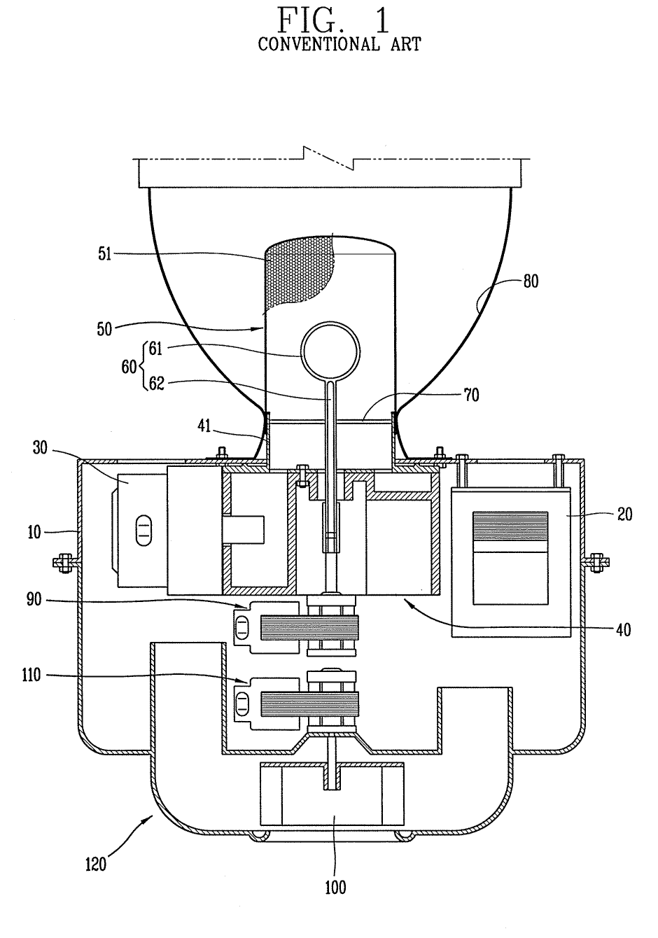

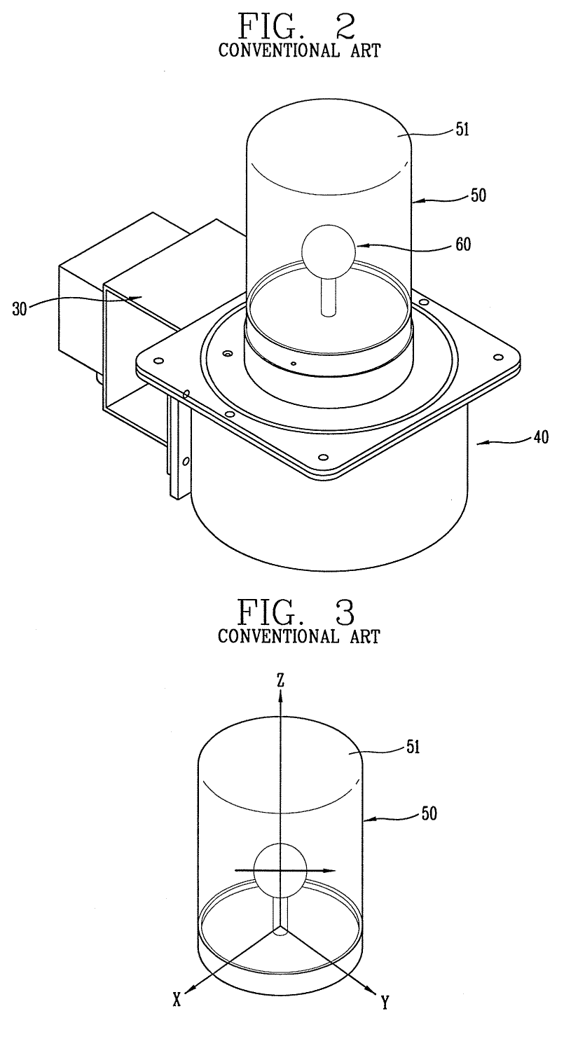

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Description will now be given in detail of the present invention, with reference to the accompanying drawings.

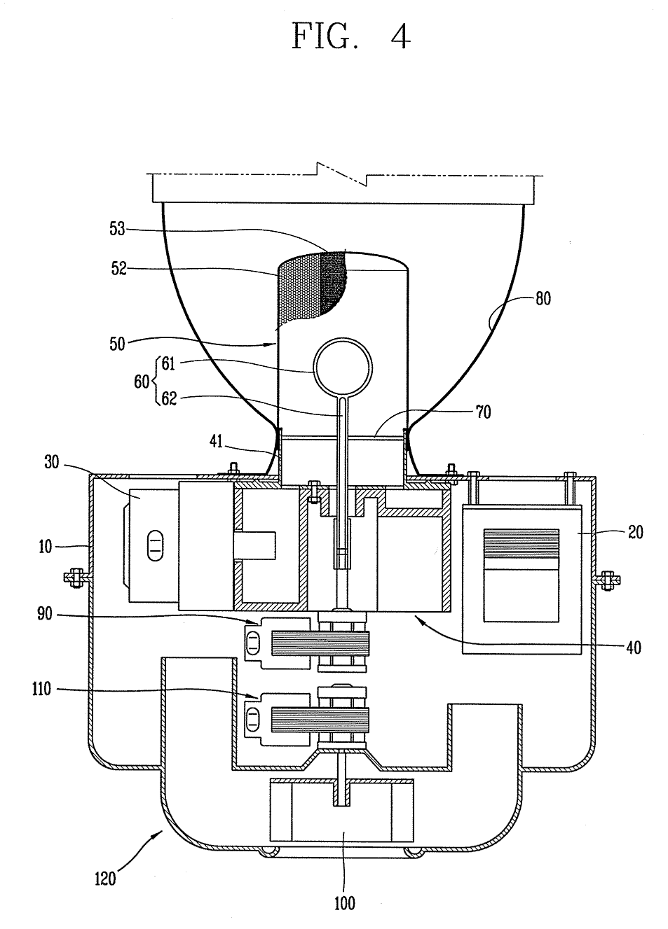

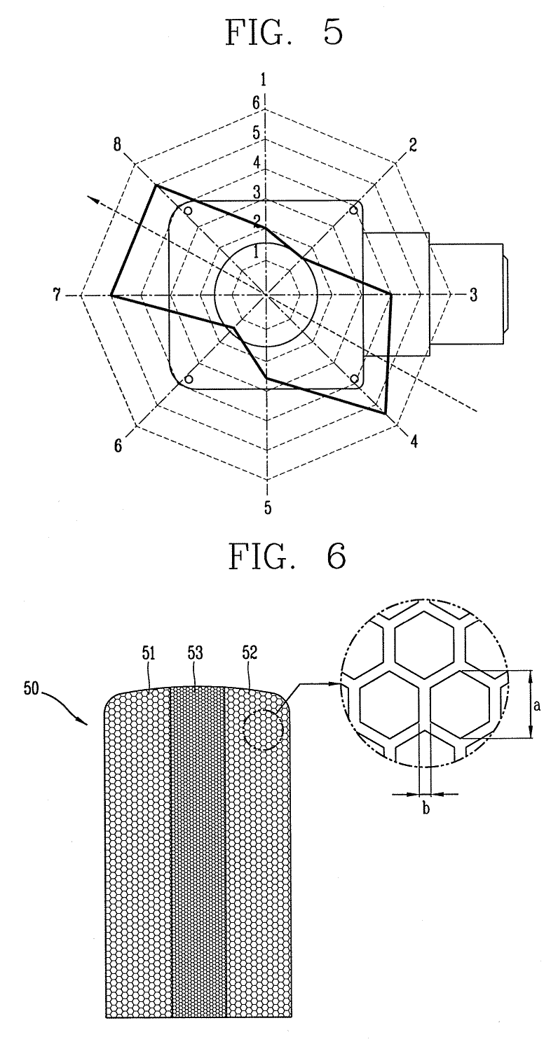

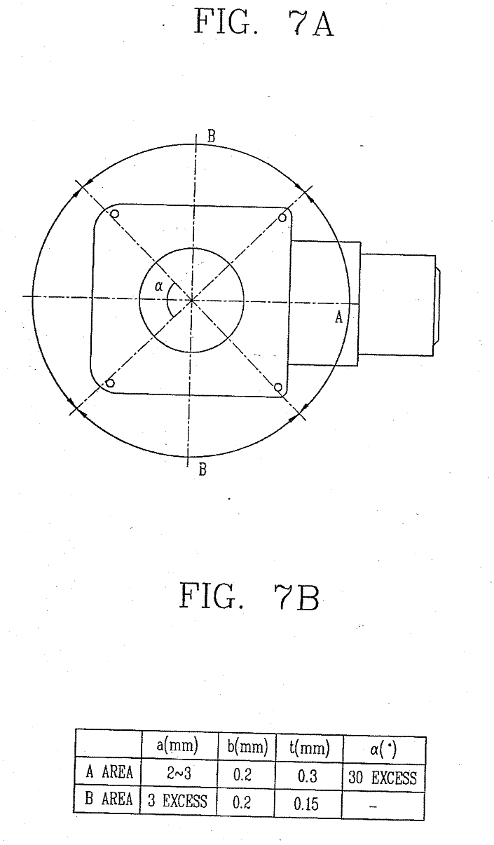

FIG. 4 is a perspective view illustrating a coupled structure between a wave guide and an electrodeless lighting system having a resonator with different aperture ratio portions in accordance with an embodiment of the present invention, FIG. 5 is a graph illustrating a direction of an electric field and a measurement result of leakage amount of microwaves in the resonator, FIG. 6 is a plane view illustrating different aperture ratio portions of the resonator of FIG. 4, and FIG. 7A is a sectional view illustrating regions of a lower surface of a wave guide, and FIG. 7B is a table illustrating measured sizes and thickness of aperture ratio portions according to the regions of the resonator of FIG. 4.

Referring to FIG. 4, an electrodeless lighting system in accordance with an embodiment of the present invention includes an electrodeless bulb 60 for emitting light by plasmarizing light emitting materials filled therein, a cylindrical resonator 50 receiving the electrodeless bulb 60 in an inner space thereof and having light transmission holes configured to shield microwaves, which are generated by a microwave generator 30 and applied to the inner space, from being discharged to the outside of the casing 10, and transmit light emitted from the electrodeless bulb 60. The resonator 50 includes a low aperture ratio portion 53 having a low aperture ratio extended from a predetermined region (e.g., a portion, part, etc) of a circumferencial direction of the resonator 50 in a height direction of the resonator 50 such that a relatively small amount of microwaves may leak; and a high aperture ratio portion 52 having a relatively high aperture ratio as compared to the low aperture ratio portion 53. In this regard, in by way of non-limiting example, the high aperture ratio portion 52 may be formed in the remainder of the circumferencial direction of the resonator 50 such that a great amount of light emitted from the electrodeless bulb 60 may be transmitted to the outside of the resonator 50.

FIG. 4 is a perspective view illustrating a coupled structure between a wave guide and an electrodeless lighting system having a resonator with different aperture ratio portions in accordance with a non-limiting embodiment of the present invention. In the above-noted embodiment, one side surface of the wave guide 40 may be connected to the microwave generator 30, and a resonator coupling member 41 may have a predetermined height protrudingly formed at an upper surface of the wave guide 40 in a height direction of the wave guide 40.

The resonator coupling member 41 may be formed having a ring shape that has a diameter smaller than that of the wave guide 40. However, it should be appreciated that the coupling member may be provided having any suitable shape or form. The center of the resonator coupling member 41 may be penetrated by the electrodeless bulb 60. A mirror 70 having a circular plate shape which has the same diameter as that of the resonator coupling member 41 may be disposed at an upper end of the resonator coupling member 41.

The electrodeless bulb 60 may extend from the center of the mirror 70 in the height direction of the wave guide 40 thereby having a predetermined length. In this regard, the electrodeless bulb may be exposed outside of the casing 10. The resonator 50 may be in contact with a peripheral surface of the resonator coupling member 41 and the mirror 70 thereby fixedly coupling the wave guide 40.

The resonator 50 may be formed as a cylindrical mesh having a generally net-shaped structure such that the electrodeless bulb 60 may be received in its inner space. Thus, microwaves may be shielded from being discharged to the outside and transferred (or delivered) to the electrodeless bulb 60, and light emitted from the electrodeless bulb 60 may be transmitted to the outside.

A lower surface of the mesh may be formed to be in contact with an outer circumferential surface of the resonator coupling member 41 (e.g., the coupling member may penetrate a lower surface of the mesh thereby coupling the resonator to the waver guide). Further, a plurality of light transmission holes 51 may be formed through a side surface and an upper surface of the mesh.

FIG. 5 is a graph illustrating a direction of an electric field and a measurement result of leakage amount of microwaves in a resonator. As illustrated in FIG. 5, it can be noted that a leaked degree of the microwaves is high in a direction (i.e., the arrow in FIG. 5) in which an electric field is applied to the resonator 50.

A leakage power P of the microwaves may be described as the following formula.
P αPmw×exp(−t/a)

where Pmw denotes power of microwave, “t” denotes a mesh thickness, and “a” denotes a length of the light transmission hole (e.g., a diagonal length). That is, a small diagonal length (e.g., a decreasing length) of the light transmission hole 51 decreases the leakage power, and a thick thickness (e.g., an increasing thickness) of the resonator 50 also decreases the leakage power. However, when the light transmission hole 51 is allowed to have a small diagonal length and the resonator 50 is allowed to have a thick thickness in the circumferential direction of the resonator 50, the leaked amount of microwaves can be reduced, which, however, causes a decrease in an amount of visible light radiated to the outside of the resonator 50, the visible light being generated from the electrodeless bulb 60. Accordingly, a light efficiency is lowered.

Therefore, the resonator 50 may be formed (or provided) with a low aperture ratio portion 53 formed at a predetermined region of the resonator 50 in which a relatively great amount of microwaves are leaked, and a high aperture ratio portion 52 formed in the remainder of the resonator 50 in which a relatively small amount of microwaves are leaked (i.e., the region of the resonator 50 except the region where the low aperture ratio portion 53 is formed). Here, in the low aperture ratio portion 53, the light transmission holes 51 have a small diagonal length and the resonator 50 has a thick thickness, whereas, in the high aperture ratio portion 52, the light transmission holes 51 have a diagonal length relatively greater than that of the low aperture ratio portion 53 and the resonator 50 has a thickness relatively thicker than that of the low aperture ratio portion 53.

The low aperture ratio portion 53 may be formed in the circumferential direction of the resonator 50 so as to have an angle of at least 15° at symmetrical portions of the resonator 50 from the center of the resonator 50 based upon a direction of the electric field applied to the resonator 50.

That is, an electrical field line, indicating the direction of an electrical field applied to the resonator may extend generally perpendicular to and passes through a central axis of the resonator. In this regard, the low aperture ratio portion may be formed, in the circumferential direction of the resonator, within a range of at least ±15 degrees of the electrical field line. Additionally, the low aperture ratio portion may be formed on opposing semi-circular segments of the generally cylindrically shaped resonator (e.g., both sides of the resonator).

The thickness of the low aperture ratio portion 53 may be about 0.3 mm. The high aperture ratio portion 52 may be positioned at the resonator, except in the region where the low aperture ratio portion 53 is formed in the circumferential direction of the resonator 50, and may have a thickness of 0.15 mm.

The diagonal length of the light transmission hole 51 formed through the low aperture ratio portion 53 is preferably about 2˜3 mm, while the diagonal length of the light transmission hole 51 formed through the high aperture ratio portion 52 is preferably more than 3 mm.

The electrodeless bulb 60 may be provided with a spherical light emitting portion 61 that has a predetermined inner volume for containing filling materials, and a fixing portion 62 formed of the same material as that of the light emitting portion 61 and extended from the light emitting portion 61. The light emitting portion 61 may be installed inside the casing 10 and the fixing portion 62 may be installed to be formed into the center portion of the wave guide 40 (e.g., the fixing portion may be mounted within the wave guide).

According to such construction, regarding the electrodeless lighting system in accordance with the embodiment of the present invention, upon inputting a driving signal to the high voltage generator 20, the high voltage generator 20 boosts an alternative current (AC) power source and applies the boosted high voltage to the microwave generator 30, which is then oscillated by the high voltage to generate microwaves having an extremely high frequency. The generated microwaves are radiated into the resonator 50 via the wave guide 40. The low aperture ratio portion 53 of the resonator 50, which is formed along the direction in which a great amount of microwaves may be leaked, can reduce the leakage amount of the microwaves to an exterior of the resonator. Accordingly, interference between the electrodeless lighting system and peripheral equipment positioned adjacent thereto can be decreased. Additionally, inactive gases filled in the electrodeless bulb 60 are excited. Accordingly, light emitting material are plasmarized to thus emit light which has a specific discharge spectrum. Therefore, the emitted light may then be reflected forward to light up a space.

It is further noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An electrodeless lighting system having a resonator with different aperture ratio portions, the electrodeless lighting system comprising:
an electrodeless bulb that emits light by plasmarizing a light emitting material filled therein; and
a resonator that receives the electrodeless bulb in an inner space thereof, the resonator having light transmission holes configured to shield microwaves, which have been generated by a microwave generator and applied to the inner space, from being discharged to an exterior of the resonator,
wherein the resonator is configured to transmit light emitted from the electrodeless bulb to the exterior of the resonator, and
wherein the resonator comprises:
a low aperture ratio portion having a low aperture ratio that extends from a predetermined region in a circumferential and height direction of the resonator; and
a high aperture ratio portion having a higher aperture ratio than the low aperture ratio portion,
wherein the high aperture ratio portion is formed in the remainder of the circumferential and height direction of the resonator.

2. The electrodeless lighting system of claim 1, wherein the resonator has a generally cylindrical shape.

3. The electrodeless lighting system of claim 1, wherein the low aperture ratio portion is configured to leak a small amount of microwaves to an outside of the resonator, and the high aperture ratio portion is configured to transmit a large amount of light to the outside of the resonator.

4. The electrodeless lighting system of claim 1, wherein the low aperture ratio portion and the high aperture ratio portion extend in an entire height direction of the resonator.

5. The electrodeless lighting system of claim 1, wherein the lower aperture ratio portion and the high aperture ratio portion are formed at the circumferential surface of the resonator symmetrical to each other with respect to a central axis of the resonator.

6. The electrodeless lighting system of claim 2, wherein an electrical field line, indicating the direction of an electrical field applied to the resonator, extends generally perpendicular to and passes through the central axis of the resonator,
wherein the low aperture ratio portion is formed, in the circumferential direction of the resonator, within a range of at least ±15 degrees of the electrical field line; and
wherein the low aperture ratio portion is formed on opposing semi-circular segments of the generally cylindrically shaped resonator.

7. An electrodeless lighting system having a resonator with different aperture ratio portions, the electrodeless lighting system comprising:
an electrodeless bulb that emits light by plasmarizing a light emitting material filled therein; and
a cylindrical resonator configured to receive the electrodeless bulb in an inner space thereof and having light transmission holes configured to shield microwaves, which have been generated from a microwave generator and then applied to the inner space, from being discharged to an exterior of the resonator, wherein the resonator is configured to transmit light emitted from the electrodeless bulb,
wherein the resonator comprises:
a low aperture ratio portion having a diagonal length configured to allow a small amount of microwaves to leak from a predetermined region in a circumferential direction of the resonator; and
a high aperture ratio portion having a diagonal length longer than that of the low aperture ratio portion, the high aperture ratio portion formed in the remainder of the circumferential direction of the resonator.

8. The electrodeless lighting system of claim 7, wherein the low aperture ratio portion is configured to leak a small amount of microwaves to an outside of the resonator, and the high aperture ratio portion is configured to transmit a large amount of light to the outside of the resonator.

9. The electrodeless lighting system of claim 7, wherein the low aperture ratio portion and the high aperture ratio portion extend in an entire height direction of the resonator.

10. The electrodeless lighting system of claim 7, wherein the light transmission hole of the low aperture ratio portion has a diagonal length of 2 mm˜3 mm, and the light transmission hole of the high aperture ratio portion has a diagonal length more than 3 mm.

11. The electrodeless lighting system of claim 10, wherein the low aperture ratio portion has the same thickness as that of the high aperture ratio portion or thicker than that thereof.

12. The electrodeless lighting system of claim 7, wherein an electrical field line, indicating the direction of an electrical field applied to the resonator, extends generally perpendicular to and passes through the central axis of the resonator,
wherein the low aperture ratio portion is formed, in the circumferential direction of the resonator, within a range of at least ±15 degrees of the electrical field line; and
wherein the low aperture ratio portion is formed on opposing semi-circular segments of the generally cylindrically shaped resonator.

13. A resonator for an electrodeless lighting system, the resonator comprising:
an inner space configured to receive an electrodeless bulb that emits light by plasmarizing a light emitting material filled therein,
wherein the resonator has light transmission holes configured to shield microwaves, generated by a microwave generator and applied to the inner space, from being discharged to an exterior of the resonator, and
wherein the resonator is configured to transmit light emitted from the electrodeless bulb;
a low aperture ratio portion having a low aperture ratio that extends from a predetermined region in a circumferential direction of the resonator; and
a high aperture ratio portion having a higher aperture ratio than the low aperture ratio portion,
wherein the high aperture ratio portion is formed in the remainder of the circumferential direction of the resonator.

14. The resonator of claim 13, further comprising a generally cylindrical shape.

15. The resonator of claim 13, wherein a low aperture ratio portion has a diagonal length configured to allow a small amount of microwaves to leak from a predetermined region in a circumferential direction of the resonator; and
a high aperture ratio portion has a diagonal length longer than that of the low aperture ratio portion.

16. The resonator of claim 13, wherein the low aperture ratio portion and the high aperture ratio portion extend in a height direction of the resonator.

17. The resonator of claim 13, wherein the low aperture ratio portion is configured to leak a small amount of microwaves to an outside of the resonator, and the high aperture ratio portion is configured to transmit a large amount of light to the outside of the resonator.

18. The resonator of claim 13, wherein the low aperture ratio portion and the high aperture ratio portion extend in an entire height direction of the resonator.

19. The electrodeless lighting system of claim 13, wherein the lower aperture ratio portion and the high aperture ratio portion are formed at the circumferential surface of the resonator symmetrical to each other with respect to a central axis of the resonator.

20. The resonator of claim 13, wherein an electrical field line, indicating the direction of an electrical field applied to the resonator, extends generally perpendicular to and passes through the central axis of the resonator,
wherein the low aperture ratio portion is formed, in the circumferential direction of the resonator, within a range of at least ±15 degrees of the electrical field line; and
wherein the low aperture ratio portion is formed on opposing semi-circular segments of the generally cylindrically shaped resonator.
